(19) United States
(12) Patent Application Publication
(10) Pub. No.: US 2019/0206595 A1
(43) Pub. Date: Jul. 4, 2019

(54) HYBRID RARE EARTH MAGNET

(71) Applicant: ABB Schweiz AG, Baden (CH)

(72) Inventors: Elio Perigo, Raleigh, NC (US); Darren Tremelling, Apex, NC (US)

(21) Appl. No.: 16/229,819

(22) Filed: Dec. 21, 2018

Related U.S. Application Data
(60) Provisional application No. 62/612,390, filed on Dec. 30, 2017.

(51) Int. Cl. H01F 1/057; H01F 41/02

(52) U.S. Cl. CPC H01F 1/0577; C22C 38/16; H01F 1/0576; H01F 41/0293

(57) ABSTRACT

A hybrid rare-earth-iron-boron hard magnetic material is constituted of two materials, a first magnetic alloy of chemical composition Nd12±0.2Fe82±0.2B6±0.2 in atomic percent with each single particle surrounded and chemically bonded to a second material constituted by copper, zinc, or a mixture of the foregoing such as brass alloys. The mixture of the first and second materials is magnetically oriented, compacted and densified such as through sintering, to optimize its mechanical and magnetic properties.

### FIELD OF INVENTION

The present application is directed to a magnet for use in motors and other applications.

### BACKGROUND

Permanent magnets are used in a wide range of applications, including but not limited to motors and generators. The type of magnet selected for the application, whether bonded or sintered, is a function of the device taking into account the magnetic flux to be provided by the magnet. The magnetic flux is related to the remanence value of the magnet, typically identified by Jᵣ. Additionally, the capacity to resist demagnetization due to external fields and/or temperature must be taken into account and this is known as intrinsic coercivity, typically identified by H_{c}. Magnets formed by alloys based on Nd—Fe—B are more expensive due to the rare earth constituents present therein.

### BRIEF DESCRIPTION OF THE DRAWINGS

In the accompanying drawings, structural embodiments are illustrated that, together with the detailed description provided below, describe exemplary embodiments of a hybrid rare earth magnet. One of ordinary skill in the art will appreciate that a component may be designed as multiple components or that multiple components may be designed as a single component.

Further, in the accompanying drawings and description that follow, like parts are indicated throughout the drawings and written description with the same reference numerals, respectively. The figures are not drawn to scale and the proportions of certain parts have been exaggerated for convenience of illustration.

FIG. 1 shows the typical microstructure of a Nd—Fe—B sintered permanent magnet;

FIG. 2a is a schematic showing the full substitution of ‘excess’ rare earth material in Nd—Fe—B magnets using Nd—Fe—B powder;

FIG. 2b is a schematic showing the full substitution of ‘excess’ rare earth material in Nd—Fe—B magnets using magnetic powder coating with substitute; and

FIG. 2c is a schematic showing the full substitution of ‘excess’ rare earth material in Nd—Fe—B magnets using a sintered magnet with grains physically separated.

### DETAILED DESCRIPTION

The present disclosure substitutes the excess of rare-earth elements existent in sintered neodymium, iron, and boron (Nd—Fe—B)-based magnets. Nd—Fe—B-based magnets with alternative elements and/or alloys such as copper, zinc or brass (mixture of copper and zinc) distributed around Nd₂Fe₁₄B grains to act as a grain boundary phase that avoids demagnetization of the magnet are proposed. The use of such alternative elements as the source for the secondary phase located proximate to the grains has the potential to decrease the magnet cost by as much as 50 percent with the same production process employed in the production of known magnets. The magnets that are yielded using the alternative elements and/or alloys such as copper, zinc and brass, are also expected to exhibit improved corrosion resistance, mechanical performance, and thermal conductivity.

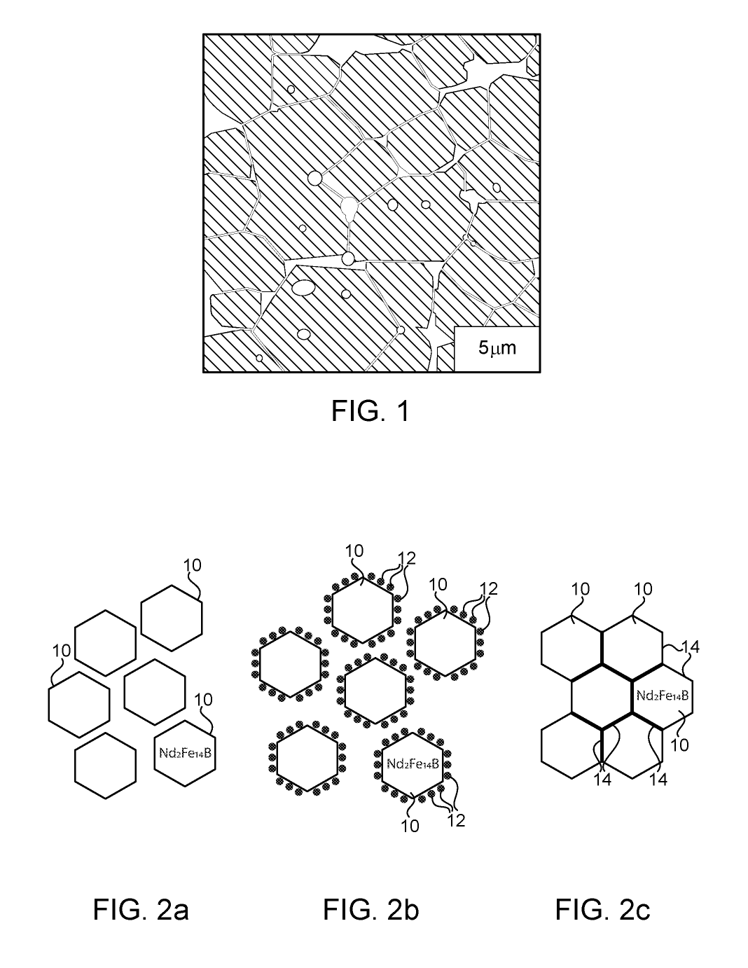

Referring to FIG. 1, the microstructure of a typical Nd—Fe—B sintered permanent magnet is shown. The dark regions correspond to magnetic grains and the white space corresponds to secondary material such as the Nd-rich phase which surrounds the magnetic grains. The secondary material is needed because it develops high Hc by separating the grains physically. The “excess” of rare-earth is found in many magnets produced today. The Nd-rich phase can account for fifteen percent of the volume of a typical magnet. The type of magnet selected for each particular application, whether bonded or sintered, is a function of the device taking into account the magnetic flux to be provided by the magnet.

In general, Nd—Fe—B-based permanent magnets are produced by a single alloy having the chemical composition expressed by the formula (in at. %): Nd15±x; Fe77±x; B8±x (in atomic percent, where 0.1≤x≤3), corresponding to 33 percent by weight of rare earth metals. In a magnet with such a composition, about 85% of its volume corresponds to the magnetic material (Nd₂Fe₁₄B phase) responsible for the magnetic properties and the remaining 15% is the “excess” material/phase. The first example case uses a magnet with 100% of magnetic material (Nd₂Fe₁₄B), having a chemical composition of Nd_{11.8}Fe_{balance}B_{5.9}, which is also known as stoichiometric composition. In this case, 26.8% (in weight) of the magnet is Nd. Therefore, a simple subtraction (33%−26.8%) yields the “excess” amount of rare-earth, which is about 6% by weight. Data from experiments conducted by researchers has shown for Nd—Fe—B magnets that the addition of Zn or Cu is beneficial to the intrinsic coercivity of the resulting magnet.

Typically the amount added of each additive element to the mixture is small, such as less than one percent by weight. A hybrid concept is proposed herein, having mixture of a stoichiometric material (Nd_{11.8}Fe_{balance}B_{5.9}), and the addition of Cu, Zn, or an alloy formed by these two elements (α-brass and α-β brass are few examples), to form the grain boundary layer. The material structure at each step of the process is depicted in FIGS. 2a, 2b, and 2c. As shown in FIG. 2a, a first powder material 10 of Nd_{11.8}Fe_{balance}B_{5.9} is produced by existing techniques. The Nd_{11.8}Fe_{balance}B_{5.9} powder 10 is then coated with a second powdered material 12. The second powder form material 12, is a Cu powder, Zn powder or brass powdered alloy. Such powders of elements and alloys are commercially available and have a mean particle size smaller than that of the Nd_{11.8} Fe_{balance} B_{5.9}.

The second material 12 is applied to cover the surface of the magnetic particles of the first material 10. Once the mixture is complete, the compound is magnetically aligned. As Cu, Zn and brass are not ferromagnetic, they will not interfere in the mixing and alignment. The mixture is compacted uniaxially and/or isostatically such as through the application of isostatic pressure. Materials exhibiting green resistance characteristics can also be expected for the green body and can be sintered under the same conditions (temperature/time/atmospheres), currently employed for many hard magnets because sintering conditions (e.g., temperature and time) for Cu and brass are comparable to those of Nd—Fe—B-based parts. Green resistance generally refers to the mechanical strength before sintering and the green body is generally the magnet after compacting and before sintering. In the parenthetical referenced above for atmosphere it is referring to among other things the chemical composition of the gas in the environment that surrounds the magnet during sintering; typically argon, hydrogen or vacuum (some partial pressure of oxygen/nitrogen).

The melting of the second material has the potential to provide a film 14 around the magnetic grains 10 as shown in FIG. 2c, aiming the development of an H_{c} property similar to that with rare earth elements in the grain boundaries. Additional annealing procedures may also be utilized, as long as the magnetic performance output is suitable thereafter. Assuming the production process is unchanged in comparison to that of traditional magnets, the cost reduction over known magnets is owed to a reduced material cost.

Table 1 lists possible scenarios regarding the impact of the elemental cost on the magnet. The most cost effective alloy is the stoichiometric one and has no excess Nd. However, this alloy has no practical use because the Hc=0 (no secondary phase separating the grains). Concerning commercially available magnets, the benchmark refers to magnets with Nd excess, responsible for an estimate cost increase of the order of 15%. With the full substitution of the rare earth excess material, even if the extra element is about one-third of the Nd by weight, the potential cost reduction is of the order of 10% (considering that the magnetic performance can be developed).

TABLE 1
Potential reduction cost of Nd—Fe—B material by full substitution
of the “excess” rare earth material.

| Composition | | | |
|---|---|---|---|
| (wt. %) | Extra element | Cost (USD/kg) | Total (USD/kg) |
| Nd_{26.8}Fe_{72.2}B₁ | — | Nd: USD 50/kg | 17.0 |
| | | Fe: USD 5/kg | (not produced) |
| | | B: included with Fe | |
| Nd₃₃Fe_{65.6}B_{1.4} | — | Nd: USD 50/kg | 19.8 |
| | | Fe: USD 5/kg | (benchmark) |
| | | B: included with Fe | |
| Nd_{26.8}Fe_{72.2}B₁ + | 6 wt. % | Nd: USD 50/kg | 17.3 |
| extra element | | Fe: USD 5/kg | −12.6% |
| | | B: included with Fe | |
| | | Cu or Zn or brass: | |
| | | USD 5/kg | |
| Nd_{26.8}Fe_{72.2}B₁ + | 6 wt. % | Nd: USD 50/kg | 17.6 |
| extra element | | Fe: USD 5/kg | −11.1% |
| | | B: included with Fe | |
| | | Cu or Zn or brass: | |
| | | USD 10/kg | |
| Nd_{26.8}Fe_{72.2}B₁ + | 6 wt. % | Nd: USD 50/kg | 17.9 |
| extra element | | Fe: USD 5/kg | −9.6% |
| | | B: included with Fe | |
| | | Cu or Zn or brass: | |
| | | USD 15/kg | |
| Nd_{26.8}Fe_{72.2}B₁ + | 10 wt. % | Nd: USD 50/kg | 18.0 |
| extra element | | Fe: USD 5/kg | −9.1% |
| | | B: included with Fe | |
| | | Cu or Zn or brass: | |
| | | USD 10/kg | |

The magnet of the present disclosure that uses a substitute element for Nd in forming the grain boundary around the Nd—Fe—B particles has better corrosion resistance than known magnets formed entirely of Nd—Fe—B constituents. The Nd—Fe—B material may be used in the core-shell (multi-component) structure in which the substitute material is used in the core portion of a multi-component permanent magnet.

The use of such substitute material may increase electrical and thermal conductivities by up to two orders of magnitude higher than the Nd material used presently along the grain boundaries. Additionally, the enhancement of eddy currents may be possible, as well as reduction of any thermal gradient across the magnet. The mechanical performance of the magnets may also be increased due to the substitute grain boundary materials because copper, for example, has an elastic moduli that is significantly higher than Nd.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application illustrates various embodiments, and while these embodiments have been described in some detail, it is not the intention of the applicant to restrict or in any way limit the scope of the appended claims to such detail. Additional advantages and modifications will readily appear to those skilled in the art. Therefore, the invention, in its broader aspects, is not limited to the specific details, the representative embodiments, and illustrative examples shown and described. Accordingly, departures may be made from such details without departing from the spirit or scope of the applicant's general inventive concept.

1. A magnet, comprising:
a first material comprising:
from 26 percent to 30 percent by weight of neodymium; from 65 percent to 73 percent by weight of iron; and from 1 percent to 1.4 percent by weight of boron; and
a second material selected from the group consisting of: copper, zinc, and brass; and
wherein the second material is provided as a coating layer upon the first material and comprises from 6 to 10 percent by weight of the magnet, the first material forming the magnetic grain of the magnet and the second material forming the grain boundary layer of the magnet.

2. The magnet of claim 1, wherein the average particle size of the second material is smaller than the average particle size of the first material.

3. A method of manufacturing a magnet, comprising:
a. providing a first material comprising neodymium, iron, and boron in a ground form;
b. providing a second material comprising one of copper, zinc and brass in a ground form;
c. mixing the first and second materials; and
d. sintering the mixture of the first and second materials to form the magnet.

4. The method of claim 3, wherein mixing the first and second materials comprises coating particles of the first material with particles of the second material.

5. The method of claim 4, wherein the average particle size of the second material is smaller than the average particle size of the first material.

6. The method of claim 3, further comprising pressing the mixture of the first and second materials prior to sintering the mixture.

7. The method of claim 3, further comprising magnetically aligning the mixture of the first and second materials prior to sintering the mixture.

8. The method of claim 7, further comprising pressing the mixture of the first and second materials after magnetically aligning the mixture and prior to sintering the mixture.
